(19) United States
(12) Patent Application Publication
(10) Pub. No.: US 2009/0193053 A1
(43) Pub. Date: Jul. 30, 2009

(54) INFORMATION MANAGEMENT SYSTEM

(76) Inventor: Garret Swart, Palo Alto, CA (US)

Correspondence Address: SONNABENDLAW, 600 PROSPECT AVE, BROOKLYN, NY, 11215, US

(21) Appl. No.: 12/021,432

(22) Filed: Jan. 29, 2008

(51) Int. Cl. G06F 17/30

(52) U.S. Cl. 707/103 Y; 707/E17.005

(57) ABSTRACT

A method is disclosed for authoring a knowledge base of semi-structured data comprising the steps of providing at least one knowledge entry in said knowledge base, said knowledge entries having mutable informational content associated therewith, defining a schema associated with said knowledge base, said schema having a plurality of hierarchical namespaces, creating a new assignment, said new assignment being defined by a prefix of at least one of said hierarchical namespaces, whereby said namespace is associated with said new assignment; and associating at least one of said knowledge entries with said new assignment by mapping said at least one knowledge entry into one of said hierarchical namespaces associated with said new assignment.

### BACKGROUND OF THE INVENTION

1. Field of the Invention

The present invention relates generally to the field of information management systems, and more specifically to semi-structured knowledge databases.

2. Background of the Related Art

Informational (i.e., knowledge-based) content is often represented and managed by semi-structured data. Particularly in the case of representing complex webs of information, semi-structured data provides the advantage of allowing for more flexible management and organization of information than may be supported by using either strictly structured or unstructured data. For example, semi-structured data may provide an appropriately-minimal level of structure when this is adequate under certain conditions, while also allowing for embedded text, semantic information, and specification of relationships and cross-references between topics when such additional representations are found necessary under other conditions. Semi-structured data is well-suited for the representation of knowledge about real-world entities in a way that is both humanly understandable and machine-interpretable.

Semi-structured data may be anywhere from largely unstructured text augmented with a few formatting tags to more rigidly-specified data formats as one might store in a traditional database table. Adding more semantic information to an unstructured document is known as “tagging.” The value of information increases as it becomes more richly tagged because the added tags make it easier for a computer to pick out actionable information from the document.

Using current state-of-the-art semantic representation techniques, richly tagging data requires restricting the domain so that the tags specific for a domain may be defined and used as part of the authoring process. For example, the domain of car repair estimates may include tags for car make, model, and year, part numbers, replacement costs, hours of labor, and labor costs. The set of tags may be defined by domain experts. There are efforts taking place in various industries to have domain experts develop and classify the tags needed for a particular domain. A set of tags specific to a particular domain may be conveniently in the form of an XML schema.

Semi-structured data may be acquired from a variety of sources. In some cases it is extracted by a reporting program accessing a structured data source as part of an integration or communication process. In other cases, a machine learning program extracts semi-structured data from an unstructured source, e.g., by using optical character recognition or natural language recognition. Semi-structured data may also be authored by an individual as part of a business process. For example, a mechanic might use a computer program as an authoring tool for creating an estimate for a car repair, and the estimation program might create an XML description of that estimate and send it to an insurance company.

Semi-structured data may also be used as a medium for collaborative editorial processes. A hallmark of a controlled editorial process is the work flow that governs the development and vetting of knowledge as it flows into the knowledge base. Typically, an editorial staff provides assignments to content developers. The assignments are completed by the content developers and their results are sent to the editors for review, possibly sent back to the content developer for revision, and eventually rejected or accepted by the editor. Accepted content is then accumulated, and at an appropriate time the results are published and distributed, possibly by printing them on paper and selling the hard copies or by delivering the data to web sites that then deliver the data electronically to the web site visitors.

Each editor or publisher may have different needs and requirements when conducting an editorial review process. For example, a publisher may assign to a writer the task of drafting an entire book, which may require take several years to complete. By contrast, a newspaper may assign a reporter an individual story, which may take from a few hours to several weeks to complete.

Editing tools for semi-structured content have been available for some time, but these tools are typically single user tools in that they allow only for a single user to modify only a single unit of content. These tools are sometimes driven by a model of the data, e.g. an XML schema, or they may allow for free form input, but in most cases these tools are still single user.

A well-known collaborative system for allowing users to create and modify simple documents is the Wiki. In its simplest form, a Wiki allows a user the ability to modify a document contained in its collection. The history of the document is preserved, thereby allowing other users to reclaim the previous versions.

Wiki technology has been used most notably for the highly popular online knowledge base known as Wikipedia (www.wikipedia.org). Wikipedia is a massive collaboratively-maintained knowledge base which is lightly tagged and whose content is predominantly natural language-based. Accordingly, while the content of a knowledge base such as Wikipedia may be displayed and searched, it may only be reliably understood by the human reader.

Some other examples of wiki-based commercial and open source solutions for collaborative development of semi-structured content include Twiki (twiki.org), Social text (www.socialtext.com), and JotSpot (inetgroupjot.com/WikiHome). Each of these Wiki systems has extended the basic text-based Wiki by including structured data.

None of the foregoing tools offer: (i) schema control, where privileged users define the schema and users to create specific tag values, (ii) schema sharing, where large numbers of items share the same schema, (iii) complex multi-level schemas, (iv) schema compliance, where data is checked on entry for compliance with the schema, and (v) assignment specification and control, where content developers are assigned a specific set of data to insert into the knowledge base.

Thus, for example, one could not use any of the foregoing tools to represent the data of a more complex knowledge base such as, for example, a cookbook, where the structured data elements may be required. Such structured data elements may include recipe names, ingredients, amounts, procedures, temperatures, times and references to other recipes.

Furthermore, none of the foregoing tools allow for controlled or managed assignment of knowledge base authoring and editing. Thus, in the cookbook example, a knowledge base manager (e.g., an editor) could not assign the writing of the book in flexible ways, e.g., assigning cold soups to one person, and souffles to another.

In order to provide such controlled or managed assignment of authoring and editing, (i.e., when knowledge authoring moves beyond what may be called “casual authoring”), a more structured framework may be desirable. In such instances, additional complexity and structure provided by schemas may allow for greater quality control and richer and more meaningful data modeling as well as advanced information processing and retrieval.

It is therefore desirable to provide a knowledge base authoring, editing and management system and method that provides (i) schema control, where privileged users define the schema and users to create specific tag values for knowledge base entries, (ii) schema sharing, where large numbers of items share the same schema, (iii) complex multi-level schemas, (iv) schema compliance, where data is checked on entry for compliance with the schema, and (v) assignment specification and control, where content developers are assigned a specific set of data to insert into the knowledge base.

It is further desirable to provide a knowledge base authoring, editing and management system and method that permits controlled or managed assignment of authoring and editing tasks by means of a semi-structured data framework.

### SUMMARY OF THE INVENTION

The present invention is directed to a new approach for the collaborative authoring of semi-structured content for a knowledge base of richly tagged data, in particular, in a previously defined domain, preferably with a pre-defined schema, a system and method for managing the collaborative development of a knowledge base in the domain.

The present invention is further directed at an information management system and method capable of providing a richer and more meaningful data output by inclusion of schema information. The schema information may include schema control, schema sharing, complex multi-level schemas, schema compliance, and assignment specification and control.

More specifically, the invention is directed to an information management system for the collaborative management of a set of semi-structured knowledge entries where the collaboration is managed through a plurality of maps, each map giving each knowledge entry a position in a hierarchical name space. Content editors may create assignments consisting of sets of knowledge entries by choosing a map and a sub tree of the hierarchical name space defined by that map. These assignments may be given to content developers giving the developer permission to modify any knowledge entry that is in or would be in that sub tree.

The entries in an assignment may be consolidated into a single data file by mapping the knowledge entries into data sub trees (such as XML sub trees) and then combining those entries into a data file based on the hierarchical name space used in the map. Data creation and editing may occur separate from a master data file (i.e., the data file containing the authoritative data), in which case, upon its completion, the newly created or edited data would be incorporated into the master data file. This incorporation may be called “checking-in” the edits, data, data file, or the like. When the data file is checked-in by the developer, the file may be parsed to retrieve individual data elements or knowledge entries. The changes in the data file thereafter will result in changes being made to corresponding knowledge entries in the master data file or creation of new knowledge entries where prior corresponding entries do not exist.

A user may manipulate knowledge entries that are part of the assignment one at a time through the use of a specialized entry browser and a set of editors, each matched to the type of knowledge entry being edited. Each knowledge entry may contain references to other knowledge entries and these references may be independent of the name space that may have been used to create the references. Knowledge entries may also contain images. Other knowledge entries may relate these images with other knowledge entries.

These and other aspects of the subject invention will become more readily apparent to those having ordinary skill in the art from the following detailed description of the invention.

### BRIEF DESCRIPTION OF THE DRAWINGS

FIG. 1 is a flow chart depicting the steps for creating an assignment in a knowledge base in a preferred embodiment of the present invention.

FIG. 2 is a flow chart depicting the steps for inserting a data entry into an assignment in a knowledge base in accordance with a preferred embodiment of the present invention.

FIG. 3 is a flow chart depicting the steps for accepting an assignment (“checking-in”) into a knowledge base in accordance with a preferred embodiment of the present invention.

### DETAILED DESCRIPTION OF THE PREFERRED EMBODIMENTS

Preferred embodiments of the present invention include a system and method for allowing knowledge creation and editing assignments to be generated, and for knowledge entries to be created and revised, in the context of a knowledge base in a predefined domain. The users of the information management system may preferably have one of three roles: (i) content developers, who make new versions of files that they have been assigned by editors; (ii) editors, who create and rename files, assign files to content developers, and approve versions of files created by content developers; or (iii) administrators, who create users and publish the knowledge base entries contained in the latest files approved by the editor to a web site or other media for dissemination.

In these preferred embodiments, the information managed by the system may be any type of information of any field or class, and may include, for example, natural language text, numerical information, multimedia information, data, graphical objects, and so on. The system may manage the information in any suitable matter, including, for example, by arranging, organizing, collecting, classifying, codifying, or disseminating the information in any of a variety of ways. The system may also manage the information, for example, by assigning editing tasks to editors, maintaining editing histories, assigning reviews of informational content to experts for authentication purposes, maintaining review histories, scheduling updates to information, and interrelating or interconnecting different pieces of information.

Preferred embodiments of the information management system may include knowledge base entries which are capable of being changed in some way, e.g., by revising, updating, or modifying the informational content of entries; revising, updating or modifying the auxiliary, formatting, or attributive aspects of entries; or changing the location of entries in an organized system of information. In this manner, the knowledge base entries may be considered “mutable”.

The knowledge base entries of the foregoing preferred embodiments may be represented as data with varying degrees of structure, including among others semi-structured data items.

In various preferred embodiments, each knowledge base entry may be specified according to a path that maps the knowledge base entry into a name in a map-specific hierarchical name space. The path may be according to any desired path representations known in the art, for example, via path representations utilized by some computer operating systems to notate file system directories and sub-directories, as will be readily comprehended by those of skill in the art. In such representations, each level of the hierarchical name space may be delimited by a pre-defined character, including among others a forward slash (“/”), a backward slash, also called a “back slash” (“\”), colons, semicolons, tabs and the like.

The foregoing hierarchical name space may be arranged in any suitable manner according to any of the programming hierarchies known in the art that include mapped relationships between classes and sub classes. A hierarchy may commonly be represented or visualized as an upside-down tree or pyramid, the top of which is known as the root. Any suitable programming code capable of storing, retrieving and/or processing hierarchical data structures may be utilized, including among others well known markup languages, for example XML, JSON, YAML and any other computer data format capable of representing data structures and associative arrays.

The languages preferably include extensible languages, i.e., languages that allow users to define metadata that provide context to the knowledge base data. The metadata used inside a knowledge base may be domain specific. Additionally, certain common elements inside any collaborative knowledge base, simply by its nature, thereby obviating the need for certain metadata elements.

Each knowledge base entry may have a type that corresponds to, and may be governed by, a schema associated with the information domain of the knowledge base. The type may specify an appropriate user interface element for users to create and edit the knowledge base entries. The user interface may be any suitable interface known in the art and may be comprised of well known user interface elements, including among others, check boxes, text boxes, drop-down lists, pick lists and others.

In preferred embodiments, the knowledge base entries in a file may be browsable and/or selectable. When selectable, it is also preferable that a selected knowledge base entry may be interactively manipulated using an appropriate user interface.

In other embodiments, each knowledge base entry may be specified according to a unique identifier. The knowledge base entries may also contain references to other knowledge base entries by their logical name. The unique identifiers may also be independent of the path name in any of the named hierarchies. The unique identifiers and the file containing the knowledge base entries are preferably maintained in an index. An index may provide the advantage of enforcing uniqueness and referential integrity constraints at check-in time.

The information management system may permit certain users (e.g. and editor or publisher) to generate one or more assignments for one or more other users (e.g., reporters or content developers) the ability to modify, add, and/or delete a knowledge base entry. In a preferred embodiment, each assignment specifies a knowledge base entry by specifying a path prefix that corresponds to a path starting with the prefix.

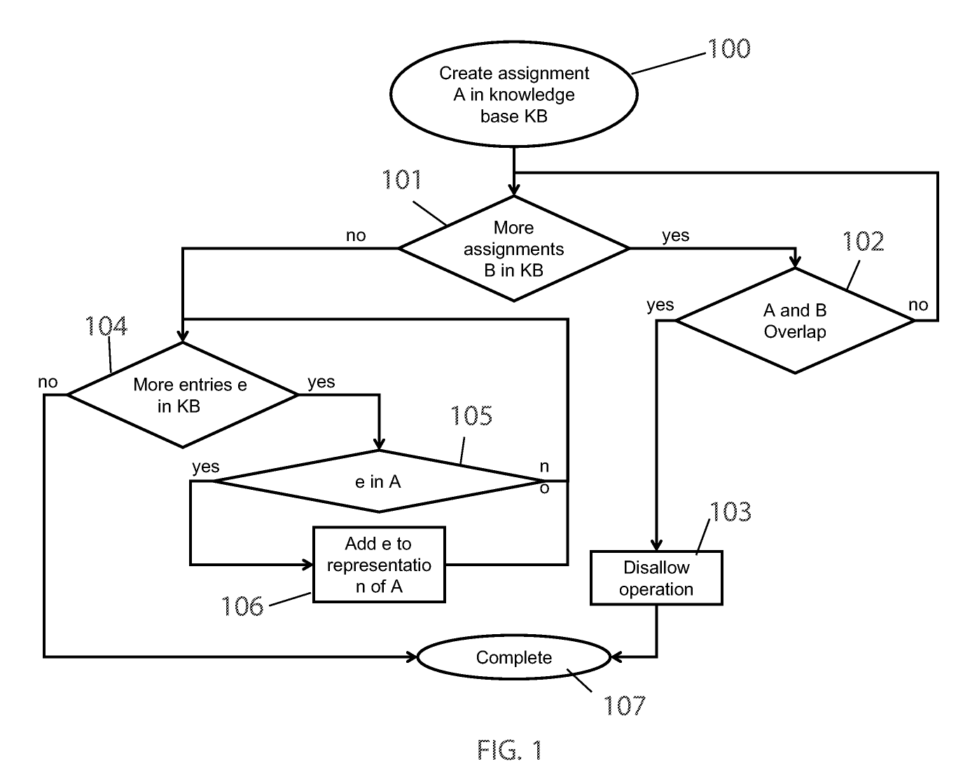

As shown in FIG. 1, creating an assignment may begin by defining assignment A in step 100. The knowledge base is then searched to determine if any other assignments are currently defined in the knowledge base in step 101. If a previously defined assignment is located, the newly defined assignment A is compared with previously defined assignment B to determine if the two overlap in step 102. An overlap occurs when the two assignments are defined in such a way that they may contain one or more identical entries (e.g., where assignment A is “all restaurants in Washington D.C.” and assignment B is “all seafood restaurants in Washington D.C.”). If an overlap is found in step 102, the operation of adding assignment A is disallowed in step 103 and the processing the assignment terminates at step 107.

If in step 102 no overlap is found between new assignment A and previously defined assignment B, processing returns to step 101, and process is repeated for all previously defined assignments.

If in step 101 the system determines that no more previously defined assignments exist, processing continues to step 104, where specific entries in the knowledge base are added to assignment A. When first entering step 104, the system determines if any previously defined knowledge base entries are found in the knowledge base. If so, the system determines in step 105 whether or not the first such previously defined entry, entry e, should be included in assignment A. By way of example, in step 105, if assignment A were “all buildings in Washington D.C.” and entry E were “The White House”, entry e would be included in the assignment. By contrast, in step 105, if assignment A were “all buildings in Washington D.C.” and entry e were “The Empire State Building”, entry e would not be included in the assignment.

Where entry is determined to be included in assignment A in step 105, processing proceeds to step 106, where entry e is assigned to assignment A. Processing returns to step 104 after step 106 or after a negative determination in step 105 (i.e., where entry e was determined not to bin in assignment A).

Processing proceeds from step 104 to final completion, step 107, when no more entries E are found in the knowledge base.

More formally, in specifying assignments, preferred embodiments may consider a set of entries E, a path alphabet P, a set of users U, and a set of maps H, each element defined as a function h: E→(P+)*, where + is the Kleene closure over string append and * is the set closure over cross product. An assignment may be specified by an element h in H and a path p in (P+)* and may represent all elements that h maps to names that start with p. That is, the entries represented by an assignment defined by hierarchy map h and path p, entries (h, p) is defined as the union over all e in E where h(e) starts with p. Each user may have a set of assignments and embodiments may ensure that no two assignments held by different users have entries that overlap.

As an example, the path “/North America/US/Washington D.C./Downtown/City-Zen”, (a restaurant) may be a member of (P+)*. The set P is the set of individual characters, e.g. P={a, b, c, . . . , z, A, . . . , Z, _}, P+ is the set of strings over those characters, e.g. “Downtown” is in P and (P+)* is an ordered set of zero or more strings. In this example, “North America”,“US”, “Washington D.C.”, “Downtown”, “CityZen”is in P+*. Further in this example, “/” is used as a separator between the strings. This is conventional when the ordered list is treated as a path in a hierarchy. The elements in H are then functions that map elements in E to paths in P+*, so h1 in H may map CityZen to the path given above.

As understood by those skilled in the art, a Kleene closure over append, usually denoted X*, where X is a set of strings, is the larger set of strings that consists of zero or more elements of X appended together. For example {“A”, “B”}* is {“”, “A”, “B”, “AB”, “BA”, “AA”,“BB”, “ABA”, “BAA”, “ABB”, “BAB”, “AAA”, “AAB”, “BBA”, “BBB”, . . . }and so on. Kleene closure of a non-empty set is infinite.

The Kleene plus, X+, is a special case that consists of one or more elements of X. It is the same as X* except that it cannot include the empty string “”. The Cartesian product of two sets, A×B, is a set of pairs, where the first element is from A and the second is from B. For example, if A={1, 2} and B={3, 4}then A×B is {(1,3), (1,4), (2, 3), (2,4)}. A* closure of A under Cartesian product is the infinite union of AUA×AUA×A×A U . . .

As another example, the set of knowledge entries E may be one relating to tourist attractions and a set of maps H, each of which may categorize the entries in E in a different way. The categorizations may be, for example, by geography, price, year of establishment, or category of interest. Elements of E may include the Eiffel Tower, the Washington Monument, Taillevent (a restaurant in Paris) , and CityZen (a restaurant in Washington, D.C.). A map h1, may be geographically organized. In such a map, the Eiffel Tower may map to the path “/Europe/France/Paris/District7/Eiffel Tower”, while CityZen might map to “/NorthAmerica/US/Washington D.C./Downtown/CityZen”.

The foregoing elements of E may further be categorized using a second map, h2, which may be organized by category, followed by shape, and then material, the Eiffel Tower may map as “/Monument/Tower/Steel/Eiffel Tower” and the Washington Monument as “/Monument/Oblisque/Stone/Washington Monument”, and further using yet another map, h3, which may be mixed, organized first by geography down to city, and then by interest, e.g. “/Europe/France/Paris/Monument/Eiffel Tower” and “/Europe/France/Paris/Restaurant/Taillevent”. In this manner, data elements may be categorized in multiple hierarchies without limit.

In generating and validating assignments of the foregoing examples, embodiments of the present invention may assure that no two current assignments contain the same element e in E. Thus, by way of example, if a user u1 is to be assigned to update all monuments in Paris, then the assignment that best captures the work to be done may be defined by h3 and the path prefix “/Europe/France/Paris/Monument/”. If a user u2 is to be assigned to update all attractions in the 7th District in Paris, the assignment may be defined by h1 and the path prefix “/Europe/France/Paris/District 7/”. However, preferred embodiments may disallow these two assignments because the element e “Eiffel Tower” exists in both sets.

By way of further example, E may be a store catalog containing a number of items including among others dental hygiene products. A map h10 may organize the items e in E by category of use, and a map H1 may organize the items e in E by brand, then product line, and finally product. A water pick may then be mapped by h10 to “/Health/Personal Care/Organ Hygiene/Power toothbrushes/Oral Irrigator/WaterPik WP-100”, while under map h11 the same element e in E might be mapped to “/Waterpik/Dental Care/WP-100”. In this example, an assignment to update all of “Waterpik” brand products may be specified by h1 and the prefix “/Waterpik/”.

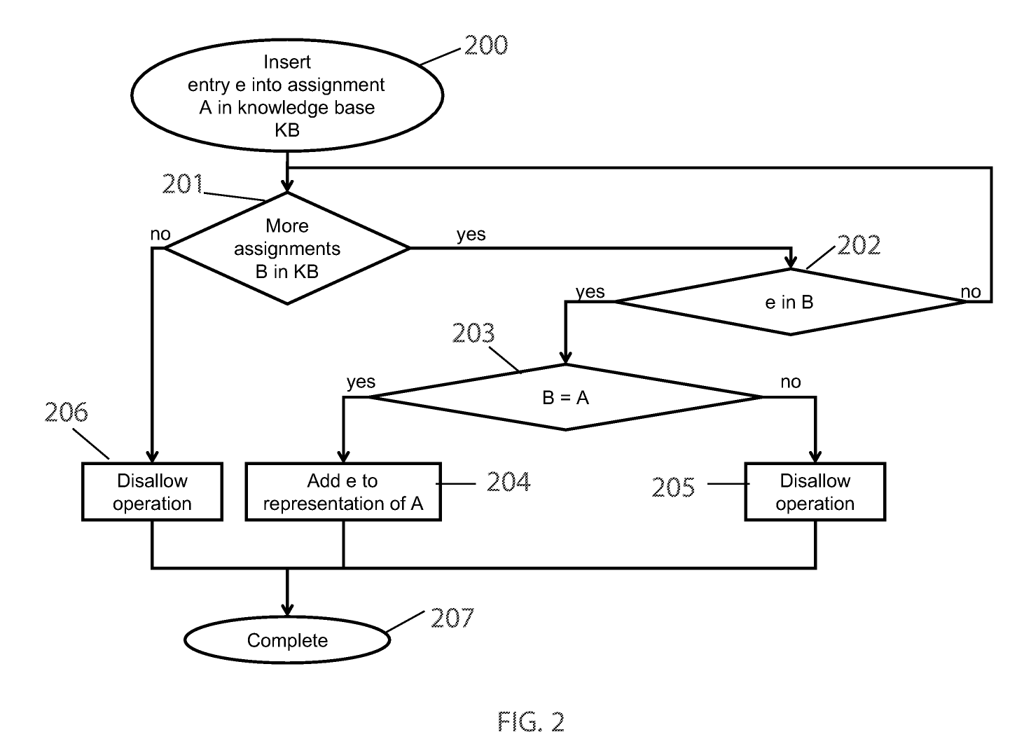

As shown in FIG. 2, users may insert new entries e in E into assignments in the knowledge base in the context of assignment A beginning at step 200. In step 201, the knowledge base is searched to determine if any assignments are currently defined in the knowledge base. If not, then the user attempting to insert entry e in the knowledge base is doing so outside the context of a valid assignment (no assignments having been created), and so the addition of the entry is disallowed in step 206. In such instance, processing of further processing is halted at step 207 because no valid assignments exist in the knowledge base, and so no entries e in E can be validly entered.

Where in step 201 an assignment B is currently defined in the knowledge base, processing continues to step 202, where the system determines if new entry e is validly a member of assignment B, as previously discussed in connection with step 105 of FIG. 1. If in step 202 the system determines that entry e is not in assignment B, then processing continues to step 201.

If in step 202 the system determines that entry e is in assignment B, then processing continues to step 203, where assignment B (i.e., the assignment found to contain entry e) is the same assignment as assignment A. If so, then the addition of entry e into assignment A is appropriate, and processing continues to step 204. If, however, assignment B is shown to be a different assignment than assignment A, the addition of entry e into assignment A would result in the same entry e appearing in two concurrent assignments, and therefore the addition of entry e into assignment A would be disallowed in step 205.

In a preferred embodiment, an editor may generate an assignment for a particular content developer, supplying that content developer with comments that specify the changes the developer is to perform, after which the developer checks-in a new version of a file with optional comments to the editor containing any comments on the work completed by the content developer.

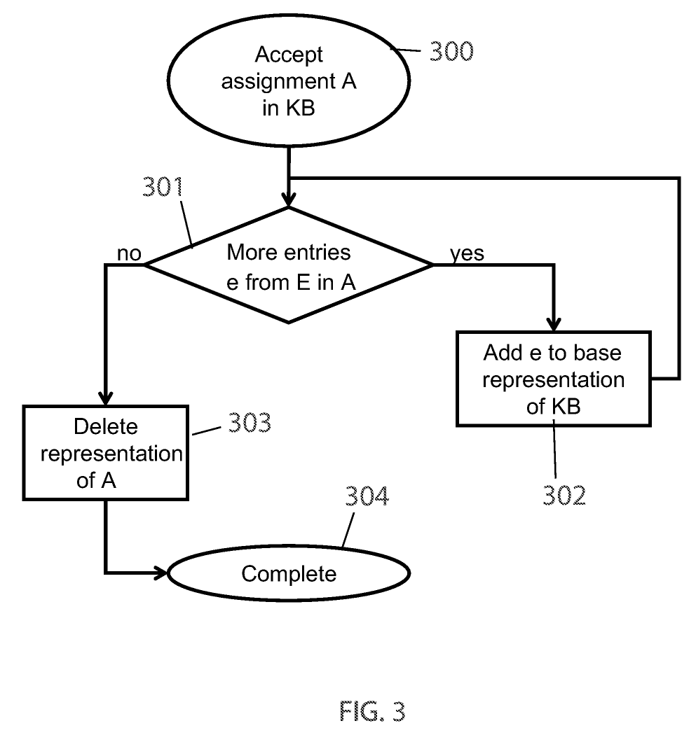

Check-in of an assignment may be completed as shown in FIG. 3, beginning at step 300. The system determines in step 301 if assignment A contains any entries e in E that have not been processed. If so, processing moves to step 302 where entry e is added to the knowledge base (i.e., entry e is “checked-in”). Processing then returns to step 301. If at any time in step 301 the system determines that no more unprocessed entries e in E exist in assignment A, then assignment A may be considered completed and no longer current. In such event, processing moves to step 303, where assignment A is delete, and then to step 304 where the check-in process is terminated.

Error rates may be minimized and costs controlled by assuring that no two current assignments include concurrent data elements from the knowledge base, thereby avoiding conflicting data entries created by different content developers and further eliminating duplicative effort and associated costs and inefficiencies.

Furthermore, assignments may be maintained in a version specific files store so that one or more versions of a file are accessible by users, and additionally, that check-in may be implemented by creating new versions.

Editors and content developers may be notified by any suitable means, e.g., by email, SMS, or commonly accessible web page of an assignment to be reviewed or performed.

Knowledge bases of preferred embodiments may consist of many top-level entries that may or may not be structurally nested. Each entry may be independently or interdependently developed. A knowledge base entry of preferred embodiments may include data of any complexity and granularity, as will be readily appreciated by those of skill in the art. The knowledge base entries themselves may be organized hierarchically so that discrete subsets of the knowledge base may be treated as a single unit of assignment to a developer.

In preferred embodiments, differing hierarchies relating to identical data entries may be used concurrently as part of the same knowledge base. Knowledge base entries may also refer to each other. While the hierarchy may be used to navigate to the reference initially, the reference may be made to an entry by its identity.

The mapping of entries into a hierarchy may be done manually, by assigning particular entries to particular paths, or implicitly by basing the hierarchy on information contained in the entries themselves.

While the present invention is illustrated with particular embodiments, it is not intended that the scope of the invention be limited to the specific and preferred embodiments illustrated and described.

What is claimed is:

1. A method for authoring a knowledge base of semi-structured data comprising the steps of:
providing at least one knowledge entry in said knowledge base, said knowledge entries having mutable informational content associated therewith;
defining a schema associated with said knowledge base, said schema having a plurality of hierarchical namespaces;
creating a new assignment, said new assignment being defined by a prefix of at least one of said hierarchical namespaces, whereby said namespace is associated with said new assignment; and
associating at least one of said knowledge entries with said new assignment by mapping said at least one knowledge entry into one of said hierarchical namespaces associated with said new assignment.

2. The method of claim 1, further comprising the steps of assigning said new assignment to a content developer and permitting said content developer to edit information associated with said at least one knowledge entry.

3. The method of claim 1, further comprising the steps of:
creating a list of current assignments having assignments stored therein;
determining whether said new assignment overlaps with any assignment stored in said list of current assignments; and
where said new assignment does not overlap with any assignment stored in said list of current assignments, storing said new assignment in said list of current assignments; and
where said new assignment does overlap with at least one assignment stored in said list of current assignments, disallowing said new assignment.

4. The method of claim 3, wherein said step of determining whether said new assignment overlaps with at least one assignment stored in said list of current assignments comprises the steps of:
(a) determining whether a knowledge entry in said new assignment maps to any hierarchical namespace associated with an assignment stored in said list of current assignments and disallowing said new assignment if said knowledge entry maps to a hierarchical namespace associated with an assignment stored in said list of current assignments; and
(b) repeating step (a) for each knowledge entry in said new assignment and each assignment stored in said list of current assignments until the first of (i) said new assignment is disallowed or (ii) all knowledge entries in said new assignment have been compared with all hierarchical namespaces associated with all assignments stored in said list of current assignments.

5. The method of claim 4, further comprising the steps of assigning said new assignment to a content developer and permitting said content developer to edit information associated with said at least one knowledge entry.

6. The method of claim 1, further comprising, after creating said new assignment, the steps of receiving an edited knowledge entry associated with said new assignment and updating said knowledge base with said edited knowledge entry.

7. The method of claim 6, further comprising the steps of assigning said new assignment to a content developer and permitting said content developer to edit information associated with said at least one knowledge entry.

8. The method of claim 1, further comprising, after creating said new assignment, the steps of:
receiving a new knowledge entry associated with said new assignment;
determining whether said new knowledge entry is allowed, and
where said new knowledge entry is allowed, updating said knowledge base with said new knowledge entry.

9. The method of claim 8, further comprising the steps of receiving an edited knowledge entry associated with said new assignment and updating said knowledge base with said edited knowledge entry.

10. The method of claim 9, further comprising the steps of assigning said new assignment to a content developer and permitting said content developer to edit information associated with said at least one knowledge entry.

11. The method of claim 3, where said new assignment does not overlap with at least one assignment stored in said list of current assignments, after creating said new assignment, the steps of:
receiving a new knowledge entry associated with said new assignment;
determining whether said new knowledge entry is allowed, and
where said new knowledge entry is allowed, updating said knowledge base with said new knowledge entry.

12. The method of claim 11, further comprising the steps of assigning said new assignment to a content developer and permitting said content developer to edit information associated with said at least one knowledge entry.

13. The method of claim 11, wherein said step of determining whether said new assignment overlaps with at least one assignment stored in said list of current assignments comprises the steps of:
(a) determining whether a knowledge entry in said new assignment maps to any hierarchical namespace associated with an assignment stored in said list of current assignments and disallowing said new assignment if said knowledge entry maps to a hierarchical namespace associated with an assignment stored in said list of current assignments; and
(b) repeating step (a) for each knowledge entry in said new assignment and each assignment stored in said list of current assignments until the first of (i) said new assignment is disallowed or (ii) all knowledge entries in said new assignment have been compared with all hierarchical namespaces associated with all assignments stored in said list of current assignments.

14. The method of claim 11, further comprising the steps of receiving an edited knowledge entry associated with said new assignment and updating said knowledge base with said edited knowledge entry.

15. The method of claim 14, further comprising the steps of assigning said new assignment to a content developer and permitting said content developer to edit information associated with said at least one knowledge entry.

16. The method of claim 14, wherein said step of determining whether said new assignment overlaps with at least one assignment stored in said list of current assignments comprises the steps of:
(a) determining whether a knowledge entry in said new assignment maps to any hierarchical namespace associated with an assignment stored in said list of current assignments and disallowing said new assignment if said knowledge entry maps to a hierarchical namespace associated with an assignment stored in said list of current assignments; and
(b) repeating step (a) for each knowledge entry in said new assignment and each assignment stored in said list of current assignments until the first of (i) said new assignment is disallowed or (ii) all knowledge entries in said new assignment have been compared with all hierarchical namespaces associated with all assignments stored in said list of current assignments.

17. The method of claim 16, further comprising the steps of assigning said new assignment to a content developer and permitting said content developer to edit information associated with said at least one knowledge entry.
